(19) United States
(12) Patent Application Publication
(10) Pub. No.: US 2018/0080248 A1
(43) Pub. Date: Mar. 22, 2018

(54) SILENT DOOR LOCK

(71) Applicant: GUANGDONG MINGMEN LOCKS INDUSTRY CO., LTD., Guangdong (CN)

(72) Inventor: Jigao Tang, Guangdong (CN)

(21) Appl. No.: 15/561,756

(22) PCT Filed: Feb. 2, 2016
(86) PCT No.: PCT/CN2016/073132

§ 371 Date: Sep. 26, 2017

(30) Foreign Application Priority Data
Mar. 31, 2015 (CN) 201510146757.6

(51) Int. Cl. E05B 17/00; E05C 1/12

(52) U.S. Cl. CPC E05B 17/0045; E05C 1/12; E05B 17/0041

(57) ABSTRACT

A silent door lock comprises a panel (1), a lining board assembly (2), a box base component (3), a handling pick (4), a buffer handle (5) and a buffer drive (6); the buffer handle (5) includes a handle (51), a volute spiral spring (52), a toggling plate (53) and a damper (54); the handle (51) is inserted into the volute spiral spring (52), the toggling plate (53) and the damper (54) in turn through a handle mounting hole (11) on the panel (1); the buffer drive (6) includes a drive (61), a drive return spring (62), a silencing retainer sleeve (63), a drive guide vane (64) and a drive lever (65); the silencing retainer sleeve (63) consists of a front cover of the silencing retainer sleeve (631), two O rings (632) and a rear cover of the silencing retainer sleeve (633). A damping chamber (6312) is arranged at the center of the front cover of the silencing retainer sleeve (631), an appropriate amount of damping grease (63120) is injected into the damping chamber (6312), and the two O rings (632) block the damping grease (63120) in the damping chamber (6312).

### TECHNICAL FIELD

The present invention relates to the door lock body structure, especially the lock body structure of the silent structure.

### BACKGROUND TECHNOLOGY

At present, the commonly used door locks are made of metal. When opening or closing the door lock, the collision noise among the metal components generates. The handle part and the drive part are the parts generating collision noise easily. In order to reduce such noise, the inventor explores many solutions. CN202417010U discloses a handle—panel mechanism, including the handle and panel. The handle penetrates the mounting hole on the panel, and matches a square core. A mosaic damper and a fixing plate are arranged behind the panel. The rotating part of the mosaic damper is arranged with a square hole, which matches the square core; there are at least two screw holes on the fixing plate, which are connected with the panel, so as to fix the mosaic damper in the panel. The handle is used conveniently and opened smoothly. Through the mosaic damper, the handle resetting can be easily controlled, and the resetting can be slowed down. This is not only safe and reliable, but also can reduce vibration among parts and relieve impact among parts, so as to avoid the generation of noise. However, the square core is used in the scheme to transfer the torque among the three parts: the handle, the damper and the lock body. There will be phantom at the joint between the square core and these three parts, so as to generate noise easily. In addition, the internal structure of the handle will cause collision, and the drive popping out instantly is also one of the main factors causing large collision sound. In order to reduce such collision sound, CN103899145A discloses a scheme to arrange the damper at the rear end of the drive to slow down the popping speed of the drive; CN104153647A discloses the scheme to arrange an O ring on the drive lever to slow down the access speed of the drive. The above two inventions slow down the access speed of the drive to the box base component to a certain degree. However, the scheme disclosed in CN103899145A shall be arranged with the specific damping rod with complicated structures, and the adaptability with the standard lock is poor; the scheme disclosed in CN104153647A has better adaptability, however, buffer is realized by means of elasticity of the O ring. After aging or fatigue of the O ring, the expansion of the drive will be largely influenced, or even be stuck. Therefore, the structure performance is unstable.

Based on the above analysis of the prior arts, there are defects existing in the current silent door locks on the structure of the handle and drive with satisfying silence effect.

### SUMMARY OF THE INVENTION

The goal of the invention is to improve the defects as occurred in prior product, to reduce virtual displacement among the transmission components, to enhance reliability and adaptability of the drive buffer, and to provide a silent door lock. The technical solution as claimed in the invention is to provide a silent door lock, comprising a panel, a lining plate component, a box base component, a handle pick, a buffer handle and a buffer drive, wherein a handle mounting hole is arranged in the panel, a limiting column is arranged above the handle mounting hole, a silencer sleeve is fit on the limiting column, and a damper fixing column is arranged at a side of the handle mounting hole; a drive hole is set on the lining panel to let the drive in and out; a drive lever fixing frame is arranged in a center portion of the box base component, a guiding groove is arranged at one side of the drive lever fixing frame, and a silencing retainer sleeve embedding groove is arranged at the other side thereof; and an end of the handling pick is arranged with a toggling piece.

The buffer handle includes a handle, a volute spring, a toggling plate and a damper; the handle penetrates the handle mounting hole on the panel, is inserted into the volute spring, toggling plate and the damper in turn, and is clamped and fixed with an elastic retaining ring; in order to reduce the friction between the rotating toggling plate and adjacent parts, there is a pad set at each side of the toggling plate; a square core hole is arranged at the center of the handle rotation axle, and two embedding grooves are arranged at sides thereof, one end of the volute spring is clipped into the embedding groove and the other end thereof is fixed on the limiting column; a toggling caulking hole is arranged in the center of the toggling plate, and a toggling caulking tenon is protrudingly arranged at both sides of the toggling caulking hole, a damping caulking hole is arranged in the center of the damper, and a damping block tenon is protrudingly arranged at both sides of the damping caulking hole, the toggling caulking hole and the damping caulking hole being fit on the handle rotation axle, and the toggling caulking tenon and damping block tenons being clipped into the embedding grooves at the sides of the handle rotation axle. A screw is adopted respectively at both ends of the damper to fix the damper with the damper fixing column on the panel. The square core is inserted into the square core hole, so that handle torque is transferred to the handle pick to open the door lock. During the opening process, when the handle is pressed for unlocking, it is necessary to overcome the torque of the volute spiral spring firstly, and enhance the hand feeling for opening; after the hand loosens grip, the elastic volute spiral torque of the volute spiral spring drives the handle for returning rapidly. At the moment, the damper generates the buffer resistance to the elastic volute spiral torque, slows down the handle returning speed, and thus reduces the sound generated when the toggling piece collides the limiting column. Compared with the prior art, the sophisticated design of the invention is that the damper and the volute spiral spring are fixed on the handle rotation axle, the damping force and elastic volute spiral torque are applied on the handle axle in the opposite directions, which can eliminate the connection virtual displacement among the handle and damper and the toggling plate, so as to further avoid the generation of the noise at the handle position.

The buffer drive includes a drive, a drive return spring, a silencing retainer sleeve, a drive guide piece and a drive lever; the silencing retainer sleeve consists of a silencing retainer sleeve front cover, two O rings and a silencing retainer sleeve rear cover; both sides of the front cover of the silencing retainer sleeve are arranged with the block tenon, which is inserted into the embedding groove of the silencing retainer sleeve in the box base component, which can fix the silencing retainer sleeve in the box base component; the damping chamber is arranged at the center of the front cover of the silencing retainer sleeve, an appropriate amount of damping grease is filled into the damping chamber, and both O rings block the damping grease into the damping chamber; the buckling tenons are arranged at both sides of the rear cover of the silencing retainer sleeve for buckling of the rear cover of the silencing retainer sleeve and front cover of the silencing retainer sleeve; the drive lever is arranged at a rear end of the drive, a center portion of the drive lever is clipped into the drive lever fixing frame, and the drive return spring, the silencing retainer sleeve and the drive guide piece are penetrated by and arranged on the drive lever. The drive lever is inserted through the silencing retainer sleeve; and an end of the handling pick is arranged with a toggling piece, rotation of which can drive backward translational motion of the drive guide piece. At the free state, rotate the handling pick to rotate the toggling piece. It drives the drive guide vane for backward translational motion, until the drive end surface is flush with the lining board assembly to reach the purpose of unlocking; when the drive end surface is flush with the lining board assembly, the drive is translated forward under applied force of the return spring, so that the drive is recovered to the free state. During movement of the drive lever, the damping grease in the silencing retainer sleeve is blocked, which can slow down the motion speed of the drive lever, so as to act as the cushion of the drive to the box base component, and slow down impact of the drive on the lining board assembly. The above buffer drive further reduces collision sound among door lock parts. Moreover, the silencing retainer sleeve is provided with exquisite structure and strong adaptability. The cushion function is mainly realized by the closed damping grease, and the performance is quite stable.

The invention reliably realizes the mute effects through above embodiments.

### DESCRIPTION OF THE DRAWINGS

FIG. 1 is the perspective view of the invention in the assembly state;

FIG. 2 is the perspective view of the buffer handle of the invention in the assembly state;

FIG. 3 is the perspective view of the buffer handle of the invention in the disassembly state;

FIG. 4 is the perspective view at the free state after assembly of buffer drive of the invention;

FIG. 5 is the structure diagram of the buffer drive of the invention in disassembly state;

FIG. 6 is the structure diagram of the silencing retainer sleeve of buffer drive of the invention.

### THE NUMERALS IN THE FIGURE ARE AS FOLLOWING

1—panel, 11—handle mounting hole, 12—limiting column, 120—silencer sleeve, 13—damper fixing column;
2—lining board assembly, 21—drive hole;
3—box base component, 31—fixing frame of the drive lever, 32—guiding groove, 33—silencing retainer sleeve embedding groove;
4—handling pick, 41—toggling piece;
5—buffer handle;
   51—handle, 511—handle rotation axle, 5111—square core hole, 5112—embedding groove, 512—handle;
   52—volute spiral spring;
   53—toggling plate, 531—toggling caulking hole, 5311—toggling caulking tenon;
   54—damper, 541—damping caulking hole, 5411—toggling caulking tenon;
   55—elastic retaining ring;
   56—pad;
   57—square core
   58—screw;
6—buffer drive;
   61—drive;
   62—drive return spring;
   63—silencing retainer sleeve, 631—front cover of the silencing retainer sleeve, 6311—fixed caulking tenon, 6312—damping chamber, 63120—damping grease, 632—O ring, 633—rear cover of the silencing retainer sleeve, 6331—buckling tenon;
   64—drive guide vane;
   65—drive lever;

### DETAILED DESCRIPTION

The invention can be implemented through the following embodiments:

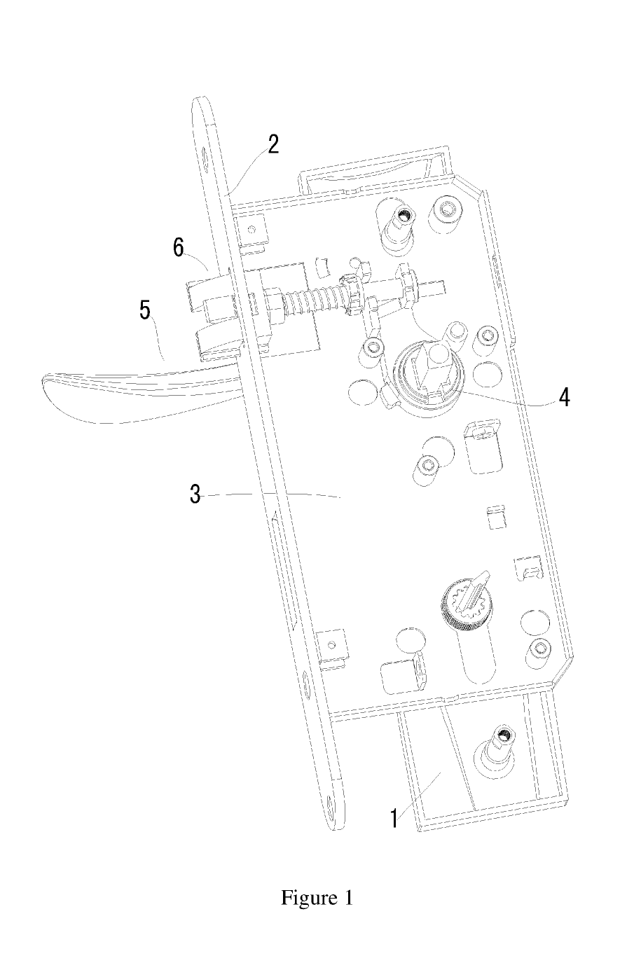

As shown in FIG. 1, the invention is arranged with a panel 1, a lining board assembly 2, a box base component 3, a handling pick 4, a buffer handle 5 and a buffer drive 6.

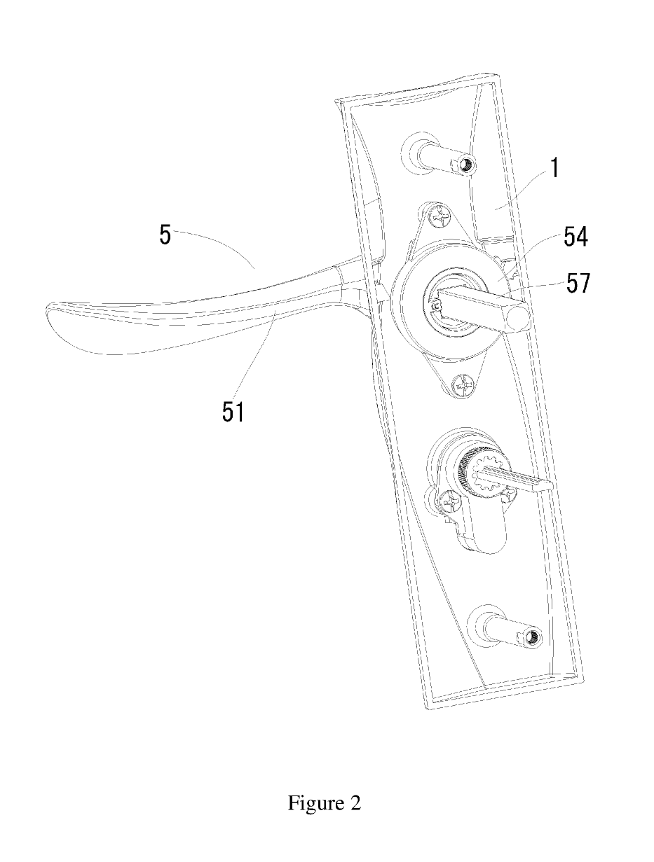

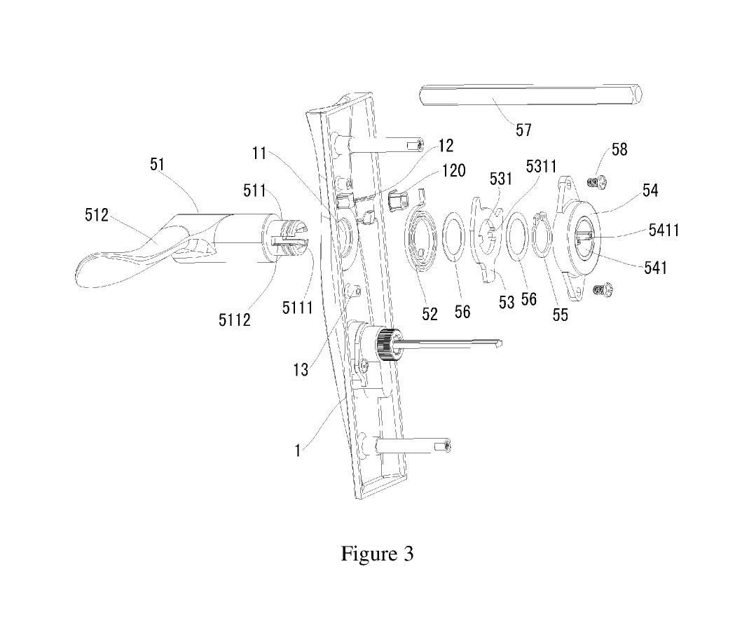

As shown in FIG. 2 and FIG. 3, a handle mounting hole 11 is arranged in the panel 1, a limiting column 12 is arranged above the handle mounting hole 11, a silencer sleeve 120 is arranged on the limiting column 12, and the damper fixing column 13 is arranged at the side of the handle mounting hole 11. The buffer handle 5 includes a handle 51, a volute spiral spring 52, a toggling plate 53 and a damper 54; the handle 51 penetrates the handle mounting hole 11 on the panel 1, and is inserted into the volute spiral spring 52, toggling plate 53 and damper 54 in turn, and is clamped and fixed with an elastic retaining ring 55; in order to reduce the friction with the adjacent components during rotation of the toggling plate 53, a pad 56 is arranged at its both sides; a limiting column 12 is arranged above the handle mounting hole 11 inside the panel 1, and a silencer sleeve 120 is inserted on the limiting column 12; a square core hole 5111 is arranged at the center of the handle rotation axle 511, and two embedding grooves 5112 are arranged at the side. An end of the volute spiral spring 52 is clamped in to the embedding groove 5112, and the other end is fixed on the limiting column 12. A toggling caulking hole 531 is arranged in the middle of the toggling plate 53, and the toggling caulking tenon 5311 is arranged at both sides of the toggling caulking hole 531. A damping caulking hole 541 is arranged in the middle of the damper 54, and the toggling caulking tenon 5411 is arranged at both sides of the damping caulking hole 541. The toggling caulking hole 531 and the damping caulking hole 541 are inserted into the handle rotation axle 511, and the toggling caulking tenon 5311 and toggling caulking tenon 5411 are inserted in the embedding groove 5112 at the side of the handle rotation axle 511. The damper 54 and the damper fixing column 13 on the panel 1 are fixed with a screw 58 at both ends of the damper 54, and the square core 57 is inserted into the square core hole 5111, so as to transfer the handle 51 torque to the handling pick 4 (refer to FIG. 1) to open the door lock. During the opening process, when the handle 512 is pressed for unlocking, it overcomes the torque of the volute spiral spring 52 firstly, and enhances the hand feeling for opening; after the hand loosens grip, the elastic volute spiral torque of the volute spiral spring 52 drives the handle 51 for returning rapidly. At the moment, the damper 54 generates the buffer resistance to the elastic volute spiral torque, and slows down the returning speed of the handle 51. Compared with the existing technology, the sophisticated design of the invention is that the damper 54 and the volute spiral spring 52 are fixed on the handle rotation axle 511, the damping force and elastic volute spiral torque are applied on the handle rotation axle 511 in the opposite directions, which can eliminate the connection virtual displacement among the handle 51, the damper 54 and the toggling plate 53, so as to further avoid the generation of the noise.

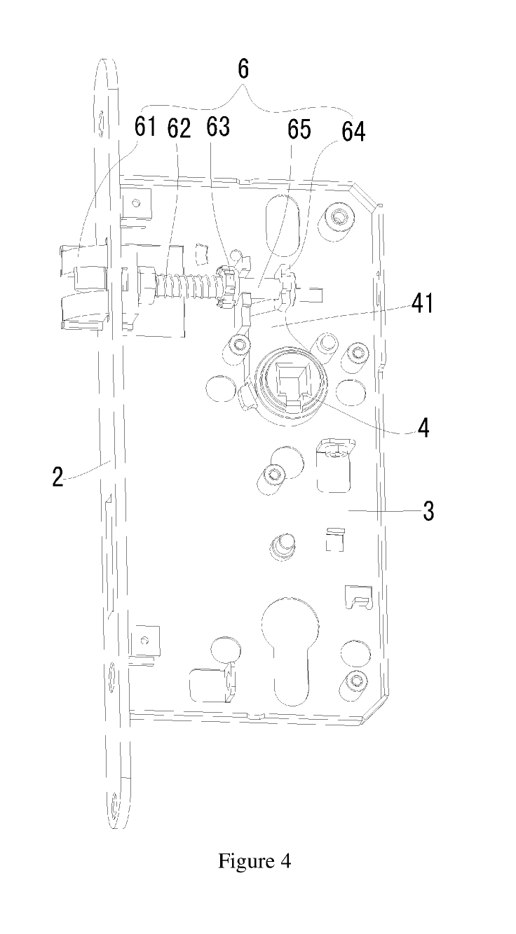

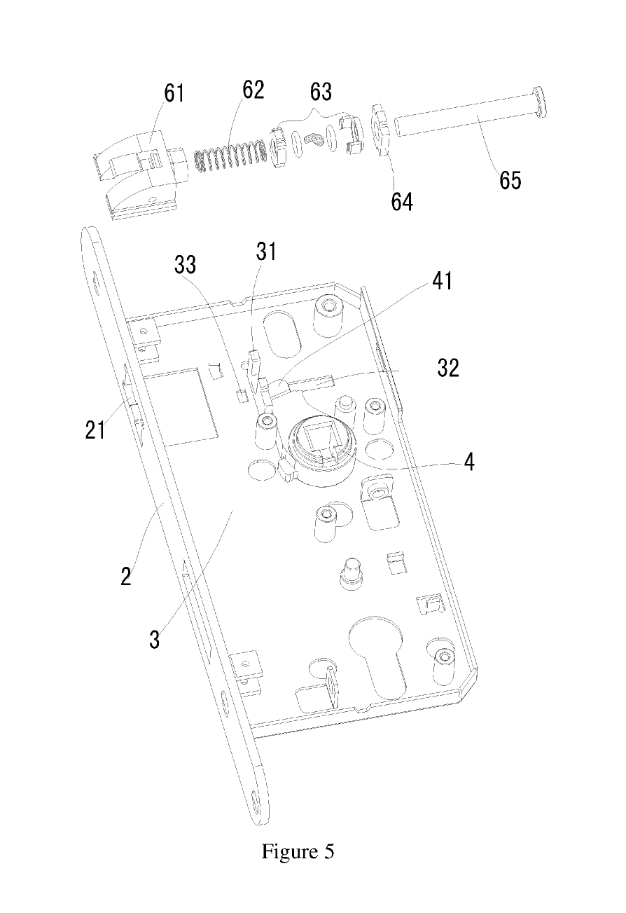

As shown in FIG. 4 and FIG. 5, the lining board assembly 2 is arranged with the drive hole 21 for the access of the drive 61; a fixing frame of the drive lever 31 is arranged in the middle of the box base component 3, a guiding groove 32 is arranged at one side of the fixing frame of the drive lever 31, and the silencing retainer sleeve embedding groove 33 is arranged at the other side; the toggling piece 41 is arranged at an end of the handling pick 4. The buffer drive 6 includes a drive 61, a drive return spring 62, a silencing retainer sleeve 63, a drive guide vane 64 and a drive lever 65. The drive lever 65 is arranged at the rear end of the drive 61, and the middle of the drive lever 65 is inserted into the fixing frame 31 of the drive lever. The drive return spring 62, silencing retainer sleeve 63 and drive guide vane 64 are arranged on the drive lever 65.

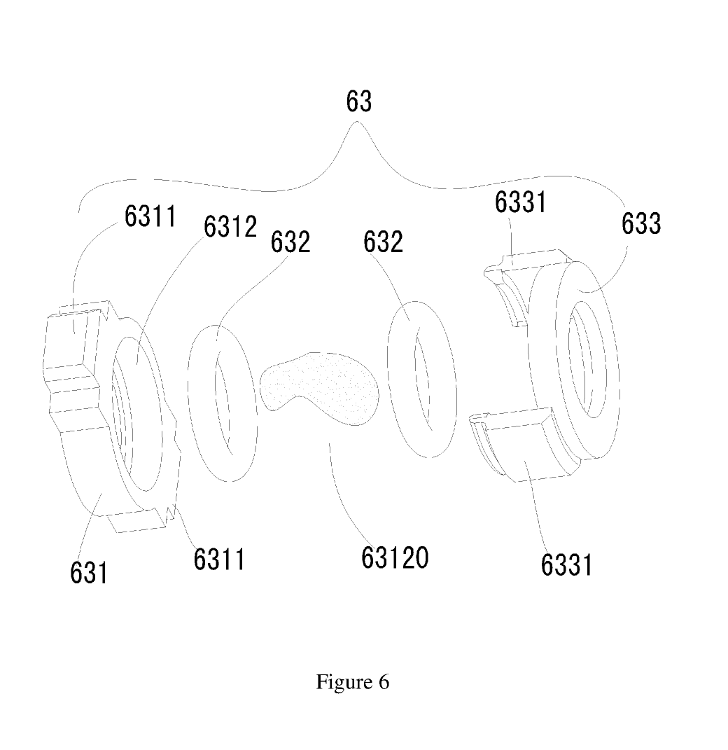

As shown in FIG. 6, the silencing retainer sleeve 63 consists of a front cover of the silencing retainer sleeve 631, two O rings 632 and a rear cover of the silencing retainer sleeve 633. Both sides of the front cover of the silencing retainer sleeve 631 are arranged with the caulking tenon 6311, which is inserted into the embedding groove 33 of the silencing retainer sleeve in the box base component 3 (please refer to FIG. 5), which can fix the silencing retainer sleeve 63 to the box base component 3. The damping chamber 6312 is arranged at the center of the front cover of the silencing retainer sleeve 631, the damping grease 63120 is filled into the damping chamber 6312, and two O rings 632 block the damping grease 63120 into the damping chamber 6312. The buckling tenons 6331 are arranged at both sides of the rear cover of the silencing retainer sleeve 633 for buckling of the rear cover of the silencing retainer sleeve 633 and front cover of the silencing retainer sleeve 631.

At the free state (please refer to FIG. 1 and FIG. 4), rotate the handling pick 5 to rotate the handling pick 4 and drive rotation of the toggling piece 41. It drives the drive guide vane 64 for backward translational motion, until the drive 61 end surface is flush with the lining board assembly 2, reaching the purpose of unlocking; when the drive 61 end surface is flush with the lining board assembly 2, the drive 61 is translated forward under applied force of the return spring 62, so that the drive 61 is recovered to the free state.

According to FIG. 6, during movement of the drive lever 65, the damping grease 63120 in the silencing retainer sleeve 63 is blocked, which can slow down the motion speed of the drive lever 65, so as to act as cushion for the access of the drive 61 to the box base component 3, and slow down the impact of the drive 61 on the lining board assembly 2.

Through the above technical solution, the buffer drive 6 further reduces collision sound among door lock parts. Moreover, the silencing retainer sleeve 63 is provided with exquisite structure and strong adaptability. The buffering function is mainly realized by the closed damping grease 63120, and the performance is quite stable.

In summary, the invention reliably realizes the silence effects through above technical solution.

### INDUSTRIAL APPLICABILITY

The silent lock of present invention has exquisite structure, strong adaptability, stable buffer performance, and can reduce the phantom among the transmission components effectively reduces the collision sound among the lock parts, so as to reliably achieve the silencing effect, and is suitable for various industrial and home use.

1. A silent door lock, comprising a panel, a lining plate component, a box base component, a handle pick, a buffer handle and a buffer drive, characterized in that: a handle mounting hole is arranged in the inner side of the panel, a limiting column is arranged above the handle mounting hole, a silencer sleeve is sleeved on the limiting column, and a damper fixing column is arranged at one side of the handle mounting hole; a drive lever fixing frame is arranged in the cental portion of the box base component, a guiding groove is arranged at one side of the drive lever fixing frame, and a silencing retainer sleeve embedding groove is arranged at the other side; the buffer handle includes a handle, a volute spring, a toggling plate and a damper; the handle penetrates the mounting hole on the panel, is inserted into the volute spring, toggling plate and the damper in turn, and is clamped and fixed with an elastic retaining ring; a square core hole is arranged at the center of the handle rotation axle, and two embedding grooves are arranged at the sides thereof, one end of the volute spring is clipped into the embedding groove and the other end thereof is fixed on the limiting column; a toggling caulking hole is arranged in the center of the toggling plate, and a toggling block tenon is protrudingly arranged at both sides of the toggling caulking hole, a damping caulking hole is arranged in the center of the damper, and a damping caulking tenon is protrudingly arranged at both sides of the damping caulking hole, the toggling caulking hole and the damping caulking hole are fit on the handle rotation axle, and the toggling caulking tenon and damping caulking tenon are clipped into the embedding grooves at the sides of the handle rotation axle.

2. The silent door lock according to claim 1, characterized in that: a screw is applied respectively at both ends of the damper to fix the damper with the damper fixing column on the panel.

3. The silent door lock according to claim 1, characterized in that: the square core is inserted into the square core hole, so that the handle torque is transferred to the handle pick to open the door lock.

4. The silent door lock according to claim 1, characterized in that: a pad is applied respectively at both sides of the toggling plate.

5. The silent door lock according to claim 1, characterized in that: the drive lever fixing frame is arranged in the center of the box base component, a guiding groove is arranged at one side of the drive lever fixing frame, and the silencing retainer sleeve embedding groove is arranged at the other side; the buffer drive includes a drive, a drive return spring, a silencing retainer sleeve, a drive guide piece and a drive lever; the drive lever is arranged at a rear end of the drive, the cental portion of the drive lever is clipped into the drive lever fixing frame, and the drive return spring and the drive guide piece are penetrated by and arranged on the drive lever; the drive lever is inserted through the silencing retainer sleeve; and one end of the handling pick is arranged with a toggling piece, rotation of which can drive backward translational motion of the drive guide piece.

6. The silent door lock according to claim 5, characterized in that: the silencing retainer sleeve consists of a silencing retainer sleeve front cover, two O rings and a silencing retainer sleeve rear cover; both sides of the front cover of the silencing retainer sleeve are arranged with the fixed caulking tenon, which is inserted into the embedding groove of the silencing retainer sleeve in the box base component, which can fix the silencing retainer sleeve to the box base component; the damping chamber is arranged at the center of the front cover of the silencing retainer sleeve, an appropriate amount of damping grease is filled into the damping chamber, and the O ring blocks the damping grease in the damping chamber; the buckling tenons are arranged at both sides of the rear cover of the silencing retainer sleeve for buckling of the rear cover of the silencing retainer sleeve and front cover of the silencing retainer sleeve.
